(19) United States
(12) Patent Application Publication
(10) Pub. No.: US 2025/0316730 A1
(43) Pub. Date: Oct. 9, 2025

(54) RUN FUEL CELL COOLANT THROUGH CATHODE INTERCOOLER

(71) Applicant: ZEROAVIA LTD, Cirencester (GB)

(72) Inventors: Stephen LAWES, Cirencester (GB); Gareth COATES, Cirencester (GB); Aajay SANKAR, Cirencester (GB)

(21) Appl. No.: 18/865,495

(22) PCT Filed: May 12, 2023
(86) PCT No.: PCT/US2023/022130

§ 371 Date: Nov. 13, 2024

Related U.S. Application Data
(63) Continuation of application No. 17/744,471, filed on May 13, 2022, now Pat. No. 12,113,252.
Application No. 17/744,471 is a continuation of application No. 18/056,651, filed on Nov. 17, 2022.

(30) Foreign Application Priority Data
Mar. 27, 2023 (GB) 2304457.1

(51) Int. Cl. H01M 8/04664

(52) U.S. Cl. CPC H01M 8/04671; H01M 2250/20

(57) ABSTRACT

A fuel cell includes a heat exchanger loop configured to circulate a heat exchanger fluid from the compressed cathode air feed to the fuel cell to pre-heat the fuel cell during fuel cell start up. Also disclosed is a fuel cell including a humidifier mated to inlet and outlet ports of the fuel cell stack. Also disclosed is a fuel cell system having audio, image, or strain sensors external to the fuel cell surface, configured for detecting a change in the external surface of the fuel cell indicative of a fault condition.

The present disclosure relates to fuel cells. The disclosure has particular utility with respect to hydrogen fuel cells for powering transport vehicles including aircraft and will be described in connection with such utility, although other utilities are contemplated.

This section provides background information related to the present disclosure which is not necessarily prior art. This section provides a general summary of the disclosure and is not a comprehensive disclosure of its full scope or all its features.

Exhaust emissions from transport vehicles are a significant contributor to climate change. Conventional fossil fuel powered aircraft engines release CO₂ emissions. Also, fossil fuel powered aircraft emissions include non-CO₂ effects due to nitrogen oxide (NOx), vapor trails and cloud formation triggered by the altitude at which aircraft operate. These non-CO₂ effects are believed to contribute twice as much to global warming as aircraft CO₂ and were estimated to be responsible for two thirds of aviation's climate impact. Additionally, the high-speed exhaust gasses of conventional fossil fuel powered aircraft engines contribute significantly to the extremely large noise footprint of commercial and military aircraft, particularly in densely populated areas.

Moreover, in surveillance and defense applications, the high engine noise and exhaust temperatures of conventional fossil fuel burning engines significantly hamper the ability of aircraft to avoid detection and therefore reduce the mission capabilities of the aircraft.

Rechargeable battery powered terrestrial vehicles, i.e., “EVs” are slowly replacing conventional fossil fuel powered terrestrial vehicles. However, the weight of batteries and limited energy storage of batteries makes rechargeable battery powered aircraft generally impractical.

Hydrogen fuel cells offer an attractive alternative to fossil fuel burning engines. Hydrogen fuel cell tanks may quickly be filled and store substantial energy, and other than the relatively small amount of unreacted hydrogen gas, the exhaust from hydrogen fuel cells comprises essentially only water.

A fuel cell is an electrochemical cell that converts chemical energy into electrical energy by electrochemical reduction-oxidation (redox) reactions. Fuel cells include an anode and a cathode separated by a membrane and an ionically conductive electrolyte. During operation, a fuel (e.g., hydrogen) is supplied to the anode and an oxidant (e.g., oxygen or air) is supplied to the cathode. The fuel is oxidized at the anode, producing positively charged ions (e.g., hydrogen ions) and electrons. The positively charged ions travel through the electrolyte from the anode to the cathode, while the electrons simultaneously travel from the anode to the cathode outside the cell via an external circuit, which produces an electric current. The oxidant supplied to the cathode is reduced by the electrons arriving from the external circuit and combines with the positively charged ions to form water according to the following equations:

$${H}_{2} \to 2 {H}^{+} + 2 {e}^{-} at the anode of the cell , \qquad Equation 1$$

$$and$$

$${O}_{2} + {4 H}^{+} + 4 {e}^{-} \to 2 {H}_{2} O at the cathode of the cell . \qquad Equation 2$$

The reaction between oxygen and hydrogen is exothermic, generating heat that needs to be removed from the fuel cell.

A typical hydrogen fuel cell produces a terminal voltage near one volt DC. To produce higher voltages, several fuel cells are assembled together to form an arrangement called a fuel cell stack, an arrangement in which the fuel cells are electrically coupled together in series to form a higher DC voltage (a voltage near 100 volts DC, for example) and to provide more power.

A typical fuel cell stack may include flow plates (graphite composite or metal plates, as examples) that are stacked one on top of the other, and each plate may be associated with more than one fuel cell of the stack. The plates may include various surface flow channels and orifices to, for example, route the reactants and products through the fuel cell stack. Several PEMs (each one being associated with a particular fuel cell) may be dispersed throughout the stack between the anodes and cathodes of the several fuel cells. Catalyst layers and electrically conductive gas diffusion layers (GDLs) may be located on each side of each PEM to form the anode and cathodes of each fuel cell. In this manner, reactant gases from each side of the PEM may leave the flow channels and diffuse through the catalyst layers and GDLs to reach the PEM.

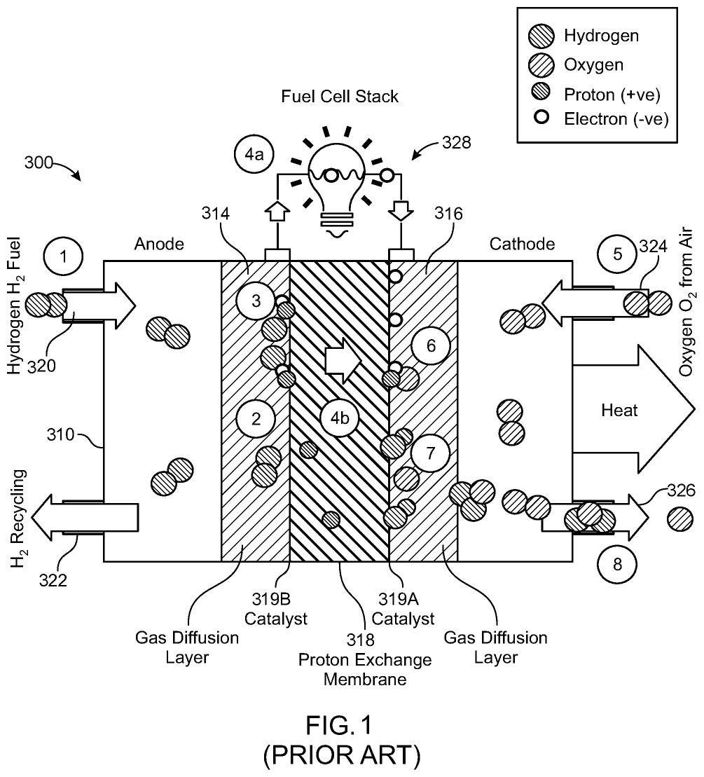

Referring to FIG. 1, a typical hydrogen fuel cell 300 comprises a housing 310 containing an anode 314, and a cathode 316 sandwiching a proton exchange membrane 318. A hydrogen fuel inlet 320 and a hydrogen recycling outlet 322 are provided on the anode side of the housing 310. An oxygen inlet 324 and a reaction product, i.e., water outlet 326 is provided on the cathode side of the housing 310. The anode side and cathode side of the membrane 318 are coated with suitable reaction catalysts 319A, 319B.

Anodic reaction according to Equation 1 as described above occurs at the anode of the cell, while a cathodic reaction as described in Equation 2 occurs at the cathode side of the cell providing a flow of electricity 328.

The fuel cell stack 300 is one of many components of a typical fuel cell system which includes various other components and subsystems, such as a cooling subsystem, a cell voltage monitoring subsystem, a control subsystem, a power conditioning subsystem, a reformer subsystem, a busbar subsystem, etc. The particular design of each of these subsystems is a function of the application the fuel cell system serves.

Hydrogen fuel cells are temperature sensitive. At fuel cell startup, a fuel cell must be slowly warmed up before it is able to produce the desired power. In the case of a High Temperature Proton Exchange Membrane (HT-PEM) hydrogen fuel cell system, the temperature of the fuel cell must be increased to about 100° C. to reach the minimum operation temperature of the fuel cell. Traditionally, heat is produced within the fuel cell by slowly reacting hydrogen with air, but this is inherently non-uniform. Warm spots are created which generate more heat, and get warmer faster, while the cool spots generate less heat and warm more slowly. The structures surrounding the fuel cell membranes are heated by thermal conduction. Thus, current fuel cell startup methods can cause degradation due to thermal shock and unstable operation. Accordingly, fuel cells may be brought up to temperature gradually, but that results in unwanted delays before full power is available (e.g., for an aircraft to takeoff). Also, some types of HT-PEM hydrogen fuel cells must be maintained at an operating range of between 100° and 160° C. to operate efficiently. Maintaining the fuel cell within its desired operating temperature range requires control of heat flow while operating in widely varying ambient temperature ranges.

Thus, a need exists to provide a system, i.e., method and apparatus to start a fuel cell and warm a fuel cell rapidly and uniformly, and to maintain a fuel cell at a desired operating temperature, using less fuel while still minimizing thermal stresses on the fuel cell. This results in faster operational readiness and up-time with less fuel cost and less thermal degradation of the fuel cell.

Existing fuel cell systems include compressors for compressing feed air, which heats the air. Thus, existing fuel cell designs cool the air after compression and before the cathode by use of a heat exchanger or intercooler, transferring the unwanted heat to the outside ambient environment. Cooling the compressed air is necessary since too hot an incoming air temperature can melt or damage the fuel cell. In one aspect the present disclosure cools the compressed air and advantageously uses the heat of compression to warm the fuel cell. This provides more uniform temperature and gentler temperature changes in the fuel cell during startup, thereby reducing thermal shock and related fuel cell degradation. The heat of compression also may be used to pre-heat the hydrogen feed, or other purposes such as, in the case of a fuel cell powered aircraft, to heat the aircraft cabin.

In accordance with the present disclosure, heat from the compressor outlet air is exchanged with a liquid coolant that is piped through the fuel cell. Heat also can be transferred to anode inlet hydrogen. Separate passages in the intercooler may be used for the anode hydrogen and for the cathode air. This permits us to cool the cathode inlet air while heating the anode inlet hydrogen. Reducing temperature differences between the cathode inlet air and anode inlet hydrogen reduces thermal stresses on the fuel cell. In order to prevent mixing hydrogen with air which could form a combustible mixture, the cathode inlet air and anode inlet hydrogen are circulated through the cathode intercooler in separate passages. A purge cycle with vacuum or inert gas may be used to prepare the system for use with hydrogen.

In one aspect, the present disclosure provides a thermal management system for pre-heating a fuel cell by transferring heat from the cathode compressor intercooler to pre-heat the fuel cell. This is an efficient way to transfer excess heat from one location to where heat is needed.

In one embodiment, heat generated in the fuel cell is used to preheat the cathode inlet air, by selectively coupling the fuel cell coolant and the compressor intercooler.

In another embodiment, the cathode inlet air and the anode inlet hydrogen are pre-heated in separate fluid-gas heat exchangers. Heat is transferred from the compressor outlet air to a fluid medium in a first heat exchanger. The fluid is circulated to a second heat exchanger that transfers the heat into the hydrogen vapor.

In one embodiment a cathode intercooler heat exchanger is thermally connected to the fuel cell coolant loop. Heat from the compressor acting on cathode inlet air is used to pre-heat the fuel cell. Heat from operation of the fuel cell is also used to pre-heat the cathode inlet air as needed.

In another embodiment, feed hydrogen is preheated by heat from the cathode compressor intercooler before entering fuel cell anode. With this embodiment anode inlet hydrogen and cathode inlet air can be made to be at the same or similar temperatures to minimize thermal differences and stresses in the fuel cell.

In yet another embodiment, a fluid heat transfer loop couples the cathode air heat exchanger to the anode hydrogen heat exchanger. This keeps hot, high-pressure air separated from flammable hydrogen. In such embodiment, the rate of heat transfer may be controlled by modulating or altering pump operating speeds and/or opening and closing system valves.

In yet another embodiment, a fluid heat transfer loop is provided to transfer heat from the cathode compressor intercooler to the anode inlet hydrogen, to ambient air, or to other aircraft systems. As before, fluid flow to each system is controlled by modulating or altering pump operating speeds and/or by opening and closing system valves. Excess heat also can be shunted to heat the aircraft cabin.

In yet another embodiment, the fluid path used to cool the compressed inlet air is configured to be switched between an external heat exchanger and the fuel cell. Switching can be binary (on/off) or proportional, and as before can be controlled by opening or closing valves, or by control of pump speeds. Control can be thermostatic, manual, or automated. The control valves or pumps may be operated by an automated device based on present parameters, and/or with some predictive capability to prepare for the next phase of operation.

According to one aspect of the disclosure there is provided a fuel cell having a cathode and an anode, a cathode air feed and an anode gas feed; a cathode air feed compressor; and a heat exchanger loop configured to extract heat from the compressed cathode air feed, wherein the heat exchanger loop is configured to circulate a heat exchange fluid from the compressed cathode air feed to the fuel cell to pre-heat the fuel cell during fuel cell start up.

In some embodiments, the heat exchanger loop is also configured to circulate heat exchanger fluid to pre-heat the anode gas feed.

In some embodiments, the heat exchanger loop is also configured to circulate heat exchange fluid from the fuel cell to pre-heat the cathode inlet air.

In some embodiments, the heat exchanger loop is configured to heat or cool the anode gas feed and cathode air feed to minimize thermal differences and stresses in the fuel cell.

In some embodiments, the heat exchanger loop comprises a cathode air feed heat exchanger and an anode gas feed heat exchanger, and further comprises a heat exchanger fluid transfer loop coupling the cathode air feed heat exchanger and the anode gas feed exchanger.

In some embodiments, the anode gas feed and the cathode air feed are maintained separate from one another in the heat exchange loop.

In some embodiments, the fuel cell comprises a hydrogen fuel cell.

In some embodiments, the fuel cell is a high-temperature proton exchange membrane (HT-PEM) hydrogen fuel cell.

According to another aspect of the disclosure, there is provided a fuel cell powered vehicle comprising a fuel cell as described above.

In some embodiments, the vehicle comprises a fuel cell powered aircraft.

In some embodiments, the aircraft comprises a further heat exchange loop configured to transfer heat from the cathode compressor heat exchanger to other systems of the aircraft.

In some embodiments, the further heat exchanger loop is configured to transfer heat from the cathode compressor heat exchanger to the aircraft cabin.

In another aspect of the disclosure, there is provided a method for pre-heating a fuel cell during startup wherein the fuel cell includes a cathode air feed and an anode gas feed; a cathode air feed compressor; and a heat exchanger loop configured to extract heat from the compressed cathode air feed, said method comprising circulating a heat exchanger fluid in the heat exchanger loop from the compressed cathode air feed to the fuel cell to pre-heat the fuel cell during fuel cell start up.

In some embodiments, the heat exchanger loop also circulates heat exchanger fluid to pre-heat the anode gas feed.

In some embodiments, the method further comprises selectively allowing circulating heat exchange fluid from the fuel cell to pre-heat the cathode inlet air.

In some embodiments, the anode gas feed and cathode air feed are heated to minimize thermal differences and stresses in the fuel cell.

In some embodiments, the heat exchanger loop comprises a cathode air feed heat exchanger and an anode gas feed heat exchanger, and the method comprises coupling the cathode air feed exchanger and the anode gas feed exchanger via a heat exchanger transfer loop.

In some embodiments, the fuel cell comprises a hydrogen fuel cell.

In some embodiments, the hydrogen fuel cell comprises a high-temperature proton exchange membrane (HT-PEM) hydrogen fuel cell.

According to one aspect of the present invention there is provided a fuel cell having a cathode and an anode, a cathode air feed and an anode gas feed; a cathode air feed compressor; and a heat exchanger loop configured to extract heat from the compressed cathode air feed, wherein the heat exchanger loop is configured to circulate a heat exchanger fluid from the compressed cathode air feed to the fuel cell to pre-heat the fuel cell during fuel cell start up.

Preferably the heat exchanger loop is also configured to circulate heat exchanger fluid to pre-heat the anode gas feed.

Preferably the heat exchanger loop is also configured to circulate heat exchanger fluid from the fuel cell to pre-heat the cathode inlet air.

Preferably the heat exchanger loop is configured to heat or cool the anode gas feed and cathode air feed to minimize thermal differences and stresses in the fuel cell.

Preferably the heat exchanger loop comprises a cathode air feed heat exchanger and an anode gas feed heat exchanger, and further comprises a heat exchanger fluid transfer loop coupling the cathode air feed heat exchanger and the anode gas feed exchanger.

Preferably the anode gas feed and the cathode air feed are maintained separate from one another in the heat exchange loop.

Preferably the fuel cell comprises a hydrogen fuel cell.

Preferably the fuel cell is a high-temperature proton exchange membrane (HT-PEM) hydrogen fuel cell.

According to another aspect of the present invention there is provided a fuel cell powered vehicle comprising a fuel cell according to an aspect of the present invention. Preferably the vehicle comprises a fuel cell powered aircraft.

Preferably the fuel cell powered vehicle comprises a further heat exchange loop configured to transfer heat from the cathode compressor heat exchanger to other systems of the aircraft.

Preferably the further heat exchanger loop is configured to transfer heat from the cathode compressor heat exchanger to the aircraft cabin.

According to another aspect of the present invention there is provided a method for pre-heating a fuel cell during startup wherein the fuel cell includes a cathode air feed and an anode gas feed; a cathode air feed compressor; and a heat exchanger loop configured to extract heat from the compressed cathode air feed, said method comprising circulating a heat exchanger fluid in the heat exchange loop from the compressed cathode air feed to the fuel cell to pre-heat the fuel cell during fuel cell startup.

Preferably the heat exchanger loop also circulates heat exchange fluid to pre-heat the anode gas feed.

Preferably the method further comprises selectively allowing circulating heat exchange fluid from the fuel cell to pre-heat the cathode inlet air.

Preferably the anode gas feed and cathode air feed are heated to minimize thermal differences and stresses in the fuel cell.

Preferably the heat exchanger loop comprises a cathode air feed heat exchanger and an anode gas feed heat exchanger and comprising coupling the cathode air feed exchanger and the anode gas feed exchanger via a heat exchanger transfer loop. Preferably the fuel cell comprises a hydrogen fuel cell.

Preferably the hydrogen fuel cell comprises a high-temperature proton exchange membrane (HT-PEM) hydrogen fuel cell.

According to another aspect of the present invention, there is provided a method for pre-heating a fuel cell during startup wherein the fuel cell comprises a fuel cell according to an aspect of the present invention, said method comprising circulating a heat exchanger fluid in the heat exchange loop from the compressed cathode air feed to the fuel cell to pre-heat the fuel cell during fuel cell startup.

Preferably the heat exchanger loop also circulates heat exchange fluid to pre-heat the anode gas feed.

Preferably the method further comprises selectively allowing circulating heat exchange fluid from the fuel cell to pre-heat the cathode inlet air.

Preferably the anode gas feed and cathode air feed are heated to minimize thermal differences and stresses in the fuel cell.

Preferably the heat exchanger loop comprises a cathode air feed heat exchanger and an anode gas feed heat exchanger and comprising coupling the cathode air feed exchanger and the anode gas feed exchanger via a heat exchanger transfer loop.

Preferably the fuel cell comprises a hydrogen fuel cell.

Preferably the hydrogen fuel cell comprises a high-temperature proton exchange membrane (HT-PEM) hydrogen fuel cell.

Another common problem with conventional fuel cell systems is that specific, uniform operating conditions (e.g., humidity) must be maintained through the stack. Fuel cell systems include humidifiers for providing heat and humidity to the incoming oxidant or hydrogen fuel stream. Without humidification, the fuel cell membrane may become too dry which reduces proton transport in the fuel cell stack and decreases the oxygen reduction reaction at the cathode, resulting in poor fuel cell function or even failure. Also, while central cells in a stack can be maintained at essentially uniform conditions, cells at either end of the stack may operate at less than optimum conditions. As a result, the fuel cells at either end of the stack cells have a tendency to become flooded, and as a consequence, to have decreased efficiency and performance. Thus, balance of fluid management of inputs and outputs for hydrogen, air and coolant is critical.

Also, as in the case of hydrogen fuel cell powered aircraft, as aircraft power demand increases, fuel cells used on aircraft contribute significantly to the total weight and size of the aircraft which also increases drag, imposing penalties on speed, range, and efficiency of the aircraft. This problem is exacerbated as more fuel cells are installed. A critical challenge in this regard is that the more stacks installed, the more weight and space required for the auxiliary systems that are required such as humidification systems and the associated hoses and ducting, etc., that make up the balance of the fuel cell system, i.e., the so-called “Balance of Plant” (BOP). That is to say, the more fuel cell stacks installed, the larger the BOP in weight and size of the various supporting components and auxiliary systems including humidifiers needed for proper function and operation of the fuel cells.

Current state of the art humidifiers for fuel cells usually are designed as counter-flow devices, meaning the moist air flows through the humidification chamber in the opposite direction to the dry air within the tubes being humidified. Counter-flow arrangements are preferred since they provide a 20% higher rate of humidification relative to non-counterflowing arrangements. What this means from a practical packaging perspective is that both of the ports that interface to a fuel cell stack, i.e., the air outlet and the moist air inlet, are in close proximity to each other, and on the same side of the humidification chamber, while the two ports on the other side of the humidification chamber, i.e., the humidifier inlet from air compressor and humidifier exhaust outlet, need to be routed away. This imposes spatial arrangement restrictions on how the humidifier can be laid out relative to the fuel cell stack.

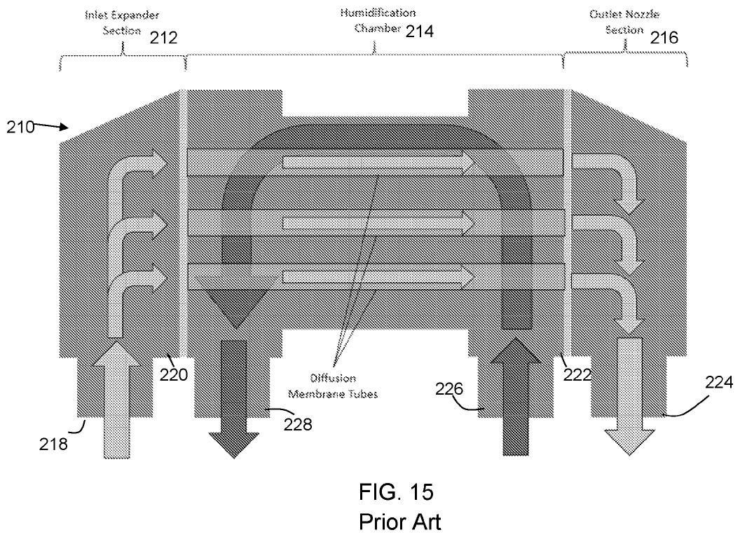

Referring to FIG. 15, conventional humidifiers 210, as sold by humidifier manufacturers worldwide, typically consist of an inlet expander section 212, a humidification chamber 214 and an outlet nozzle section 216. The inlet expander section 212 is a channel that serves to change the direction and shape of the airflow from a circular inlet hose-port 218 on the bottom of the humidifier housing for introduction of pressurized air from the fuel cell system compressor, to match the rectangular cross section 220 going forward into the humidifier humidification chamber 214. The outlet nozzle section 216 performs the opposite function, funneling the now humidified outlet air back from the humidifier rectangular cross section 222 to a downward facing circular hose port 224 on the bottom of the humidifier housing for introducing the humidifier air to the fuel cell stack. The humidification chamber 214 has two more circular, downward-facing ports, an inlet port 226 for introducing moist air from the fuel cell stack exhaust, and an outlet port 228 for the spent air to exit. Because the fuel cell ports are downward facing, and the outlet ports of a conventional humidifier also are downward facing, space is needed to turn the flows 180°, which subject to the minimum turn radius of the connecting hoses is also very space consuming and adds unnecessary hose length. Shorter hoses and channels lower the weight, volume and pressure loss in tubing allowing for higher performance and power density of the system. This design adds to the BOP.

Existing approaches combine multiple independent fuel cell stacks to achieve required power and voltage. However, multiple independent fuel cell stacks must each be supported with their own BOP components, mounting structure and properly scaled flow channels creating material redundancy. The opportunity exists to consolidate where possible multiple smaller components can be combined to a larger, more space efficient component, particularly given the requirement to turn the flows 180° discussed previously. In accordance with the present disclosure, we provide “superstacks” of multiple fuel cell stacks tightly mechanically assembled together. We also provide a single, large-sized, novel humidifier that is configured to directly mate to the fuel cell stacks making up the superstack.

The balance of plant (BOP) is sized, consolidated and packaged at the superstack level. BOP includes fluid management of inputs and outputs for hydrogen, air, and coolant. As so provided, the mass (weight) and volume of the BOP is reduced as compared to conventional fuel cell systems of comparable capacity.

In a preferred embodiment, our superstack comprises three fuel cell stacks tightly mechanically assembled together. The fuel cell superstack has three air inlets configured to be fed from the output of the humidifier and three air exhausts configured to feed the moist air inlet on the humidifier. Since these are 3-1 interfaces, a 3-1 manifold is required on each.

In accordance with another aspect of the present disclosure, we provide a humidifier with a bespoke air routing, i.e., humidifier having a novel integral manifold configured to directly connect the humidifier to the multiple inlets of the fuel cell superstacks, thereby eliminating substantial weight and volume of hoses and ducting making up a conventional fuel cell system BOP. More particularly, because a humidifier outlet's primary function is to route the outlet air from the humidifier to a single port of circular cross section of the fuel cell, we have designed our humidifier integral manifold to split the flow from the humidifier to the three inlets on the fuel cell superstack as a direct mate. In similar fashion, we provide a novel compact manifold for connecting the multiple fuel cell exhaust outlets of our fuel cell superstack to a single outlet port.

Additionally, the BOP's sensors and valves can be integrated directly into their ideal locations in the novel compact manifold.

More particularly, in one aspect we provide a fuel cell system comprising a plurality of fuel cell stacks mechanically and electrically assembled to one another to provide a desired power and output voltage, and including a humidifier directly mated to inlet ports of the individual fuel cell stacks. In one aspect the fuel cell system comprises three fuel cell stacks electrically connected in series, or three fuel cell stacks electrically connected in parallel.

In one aspect, the fuel cell system comprises an air compressor, wherein the humidifier includes an inlet section having an inlet configured for fluid connection to the air compressor.

In another aspect, the humidifier is directly mated to the fuel cell stack to introduce humid air to the fuel cell stack at an anode side of fuel cells in the fuel cell stack.

In still yet another aspect, the humidifier is directly mated to the fuel cell stack to introduce humid air to the fuel cell stack at a cathode side of fuel cells in the fuel cell stack.

In one aspect, exhaust from the fuel cells in the fuel cell stack is directly routed to an inlet port of the humidifier.

In another aspect, the humidifier includes an outlet directly connected via an integral manifold to inlet ports of the fuel cells in the fuel cell stack.

In a further aspect, the humidifier comprises a counter-flow humidifier.

In yet another aspect, we directly mate and connect the exhaust from plural fuel cell stacks to the inlet port of the humidifier.

In a further aspect, we provide a method for reducing the weight and volume of a fuel cell system comprising a plurality of fuel cells and humidifier, comprising mechanically and electrically assembling a plurality of fuel cell stacks to one another to provide a desired power and output voltage, and directly mating the humidifier to inlet and outlet ports of the individual fuel cell stacks.

In one aspect of the method, the fuel cell stacks are electrically connected in series.

In one aspect of the method, the fuel cell stacks are electrically connected arranged in parallel.

In a further aspect of the method, the fuel cell system comprises an air compressor and including the step of directing air from the air compressor into an inlet section of the humidifier.

In one aspect of the method, humid air from the humidifier is introduced at an anode side of fuel cells in the fuel cell stack.

In yet another aspect of the method, humid air from the humidifier is introduced at a cathode side of fuel cells in the fuel cell stack.

In yet a further aspect of the method, exhaust from the fuel cells in the fuel cell stack is directly routed to an inlet port of the humidifier.

In yet another aspect of the method, the humidifier includes an outlet directly connected via an integral manifold to inlet ports of the fuel cells in the fuel cell stack.

In a further aspect of the method, the humidifier comprises a counter-flow humidifier.

In yet another aspect, we provide a fuel cell powered comprising a fuel cell system, comprising a plurality of fuel cell stacks together and mechanically and electrically connected including a humidifier directly mated to inlet ports of the fuel cell stacks.

Disclosed is a method and system for monitoring and diagnosing a fault in a fuel cell system. More particularly, there is provided a fuel cell system comprising at least one fuel cell having an external surface; and one or more of audio, image, and/or strain sensors on or external to the fuel cell surface, configured for detecting changes, e.g., swelling, vibrating, temperature changes, sounds, etc. in or emanating from the external surface of said fuel cell indicative of a fault condition.

In one embodiment, the sensors are selected from the group consisting of a visual spectrum camera, an IR camera, an IR sensor, and a UV-responsive camera. In such embodiment, a plurality of the cameras which preferably include fisheye lenses, are arranged so that a plurality of the external surfaces of the fuel cell substantially fill the field of view of the cameras.

In another embodiment, the sensors are selected from the group consisting of an ultrasound transducer, a piezoelectric sensor, a vibration sensor, and a surface acoustic wave detector. In such embodiment the sensors may be affixed to microfabricated within an external surface of the fuel cell.

In another embodiment, the sensor comprises a mass spectrometer sensor, and including at least one ionizing beam source directed toward the cell.

The sensors preferably are ruggedized and/or meet certain operating standards: e.g., temperature range that the sensors are functional, e.g., −45° C. to 125° C. If the sensors form the part of the fuel cell, then DO160 standard is applicable. Also, the sensors may be configured to operate under exposure to cosmic rays.

In a preferred embodiment, multiple sensors are disposed to detect multiple external surfaces of the fuel cell.

Preferably the fuel cell comprises a hydrogen fuel cell.

In another embodiment, one or more of the external surfaces of the fuel cell is patterned. The fuel cell may be a hydrogen fuel cell, or the fuel cell may be selected from the group consisting of a phosphoric acid fuel cell, a solid oxide fuel cell, a molten carbonate fuel cell, and an alkaline fuel cell.

In a particular embodiment, the fault condition is associated with at least one of the following defective subsystems: a membrane, a cooling subsystem, a voltage monitoring system subsystem, a control subsystem, a power conditioning subsystem, a reformer subsystem, and a busbar subsystem.

The present disclosure also provides a method for detecting a fault condition in a fuel cell which comprises providing a fuel cell system with one or more audio, image or strain sensors above described, activating the sensor(s), detecting changes in an external surface of the fuel cell, and generating an alert signal when a change in the external surface is detected.

In one embodiment of the method, the sensor comprises a visual camera, an IR camera, an IR detector, or a UV-camera.

In another embodiment of the method, the sensor comprises a piezoelectric sensor, a vibration sensor, a surface acoustic wave detector or a mass spectrometer sensor.

In yet another embodiment of the method, the sensor comprises an IR or ultrasound sensor, and includes the steps of directing infrared energy pulses into an interior of the fuel cell and monitoring the external surface of said fuel cell for changes.

In yet another embodiment of the method, the one or more sensors comprise a mass spectrometer sensor, including the steps of directing an ionized beam toward the surface of the fuel cell, and detecting ionization products produced using the mass spectrometer sensor.

The present disclosure also provides an article comprising a computer readable storage medium storing instructions to cause a process-based system to: compare changes in at least one surface parameter of a fuel cell detected by an audio, image or strain sensor, and in response to said changes, determine whether said changes are caused by a fault condition in said fuel cell.

In a particularly preferred embodiment, the fuel cell system as described above is employed to power an aircraft.

Further areas of applicability will become apparent from the description provided herein. The description and specific examples in this summary are intended for purposes of illustration only and are not intended to limit the scope of the present disclosure.

Further features and advantages of the disclosure will be seen in the following detailed description, taken in conjunction with the accompanying drawings. The drawings described herein are for illustrative purposes only of selected embodiments and not all possible implementations and are not intended to limit the scope of the present disclosure.

FIG. 1 is a cross sectional view depicting a conventional prior art fuel cell;

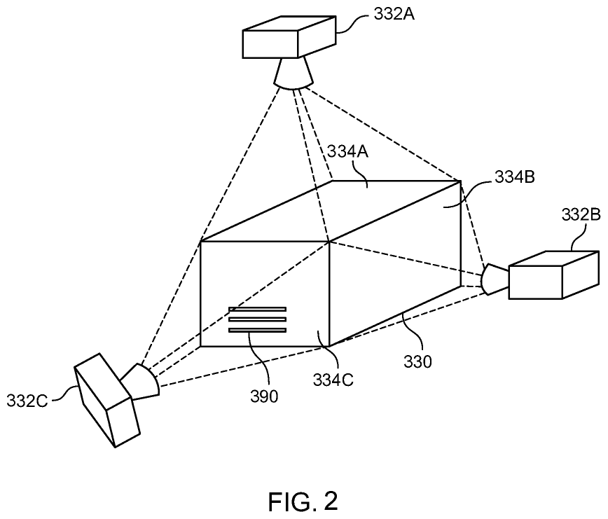

FIG. 2 is a schematic view of a fuel cell with a fault detector system in accordance with a first embodiment of the disclosure;

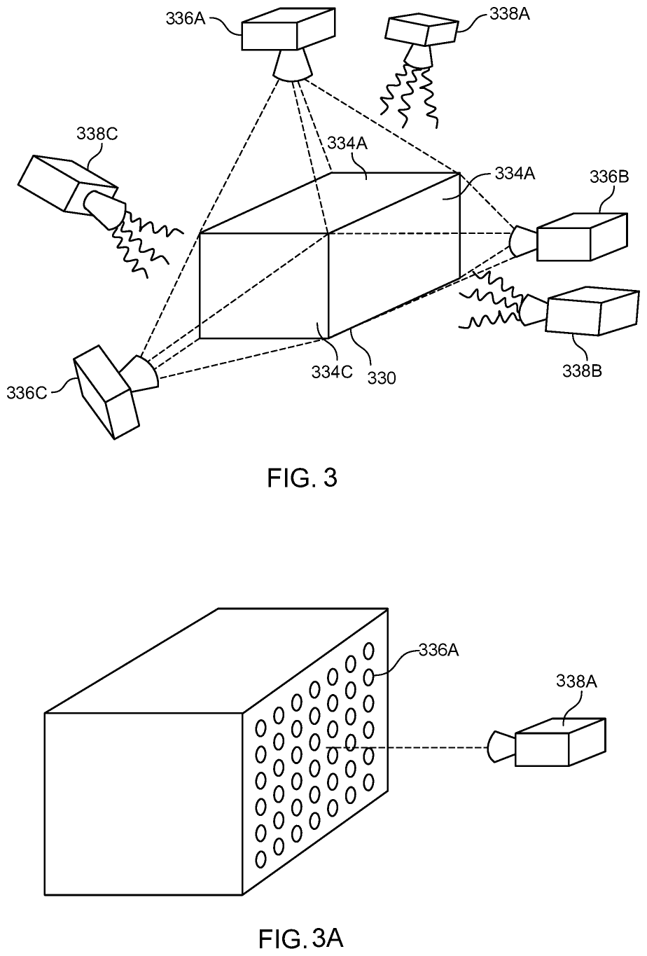

FIGS. 3 and 3A are views similar to FIG. 2, of second and third embodiments of the disclosure;

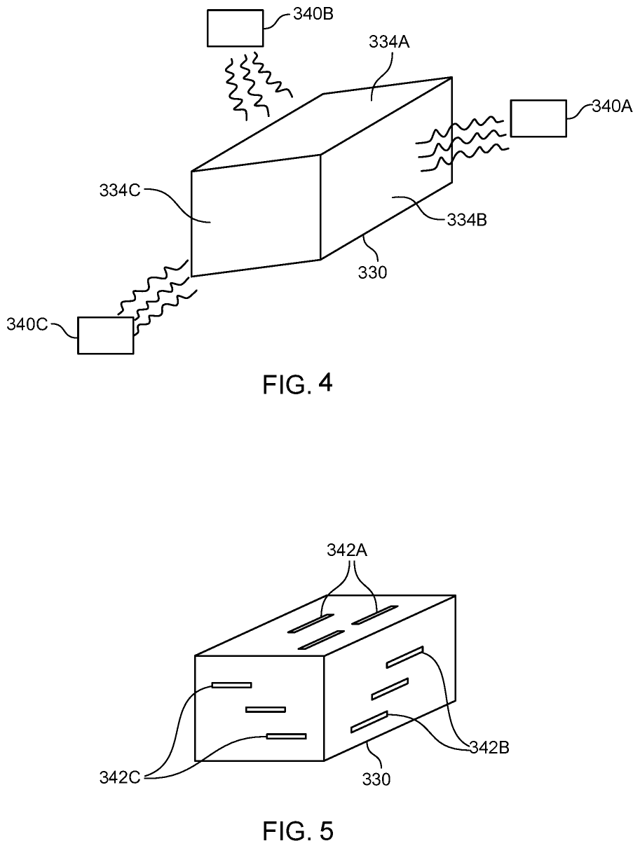

FIG. 4 is a view similar to FIG. 2, of a fourth embodiment of the disclosure;

FIG. 5 is a view similar to FIG. 2, of a fifth embodiment of the disclosure;

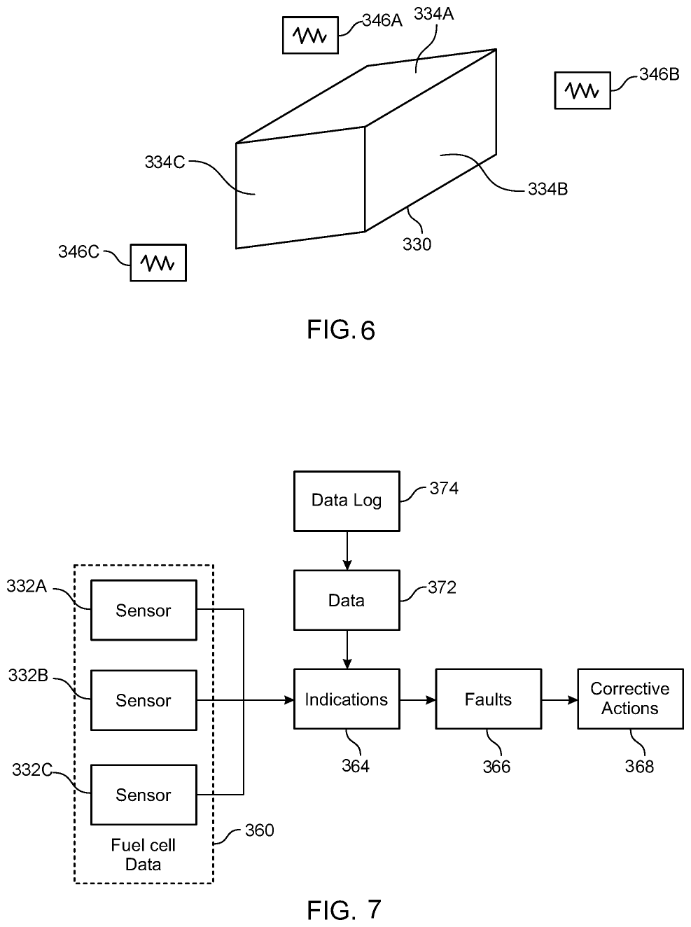

FIG. 6 is a view similar to FIG. 2, of a sixth embodiment of the disclosure;

FIG. 7 is a block diagram illustrating the detection of faults in a fuel cell in accordance with the present disclosure;

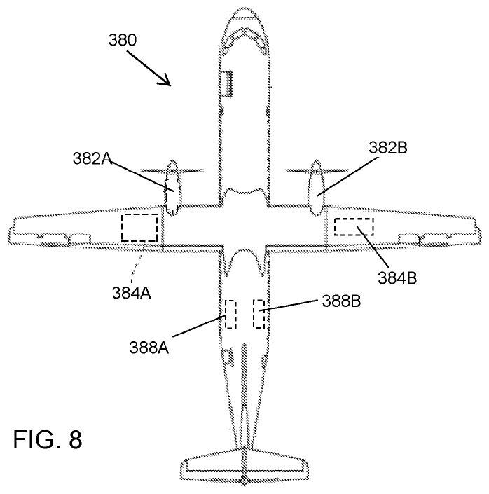

FIG. 8 is a schematic view of a fuel cell with a fault detector system installed on an airplane in accordance with the present disclosure;

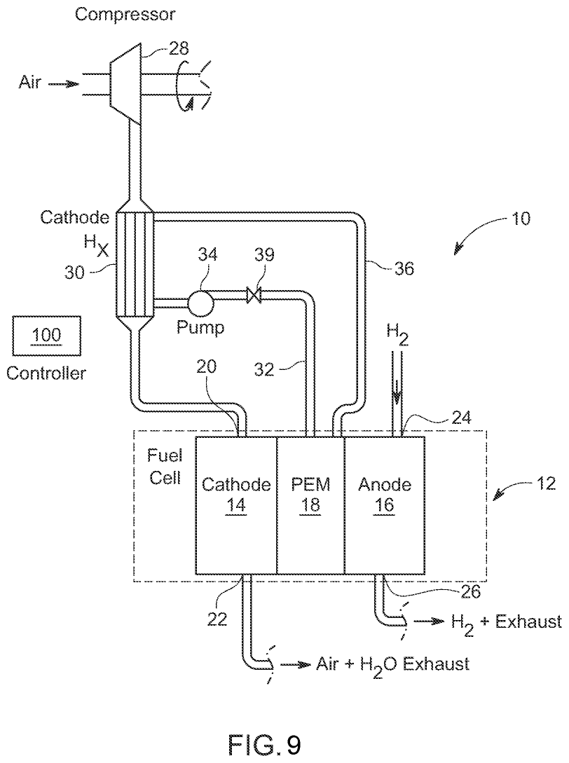

FIG. 9 is a schematic view of a hydrogen fuel cell system in accordance with a first embodiment of the disclosure;

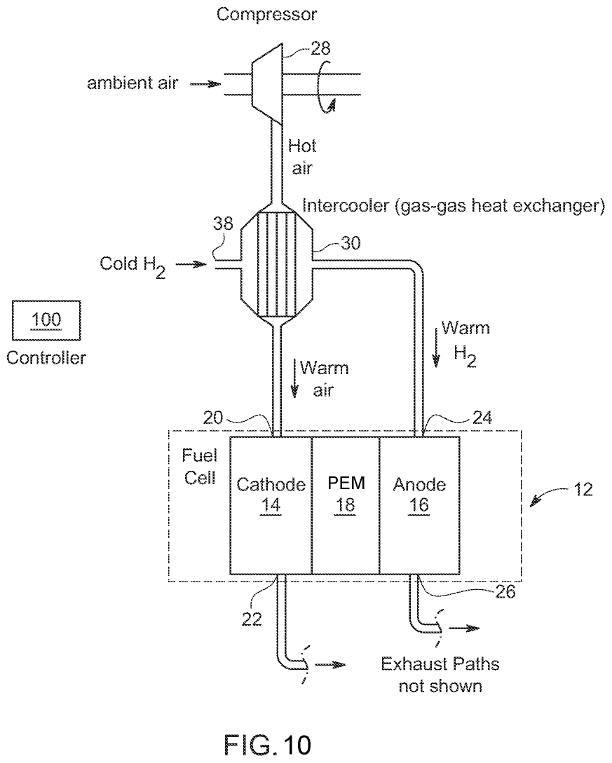

FIGS. 10-12 are views similar to FIG. 9 of second, third and fourth embodiments;

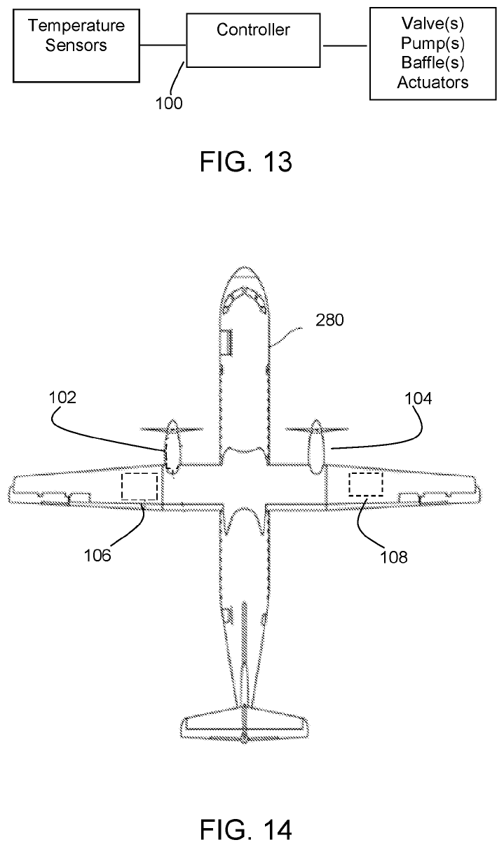

FIG. 13 is a block diagram of a controller configured for use with a fuel cell in accordance with the present disclosure;

FIG. 14 is a schematic view of a hydrogen-electric engine installed on an airplane in accordance with the present disclosure;

FIG. 15 is a cross sectional view of a conventional fuel cell system humidifier;

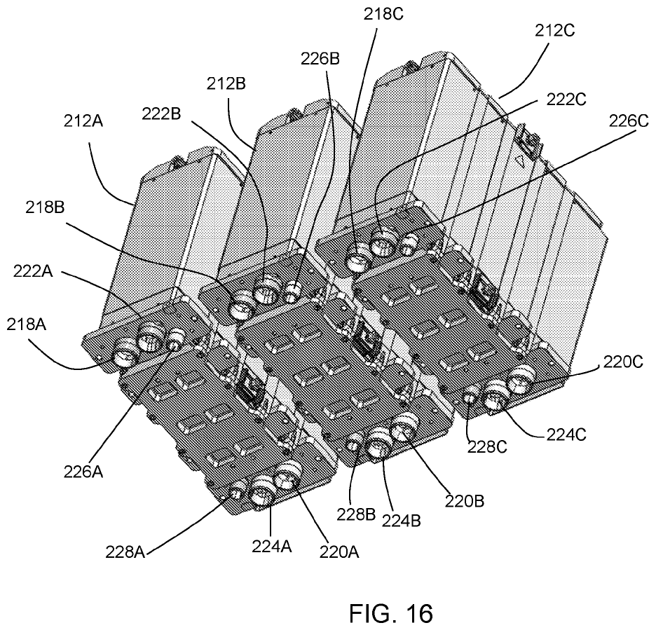

FIG. 16 is a perspective view of a three-fuel cell “superstack” in accordance with the present disclosure;

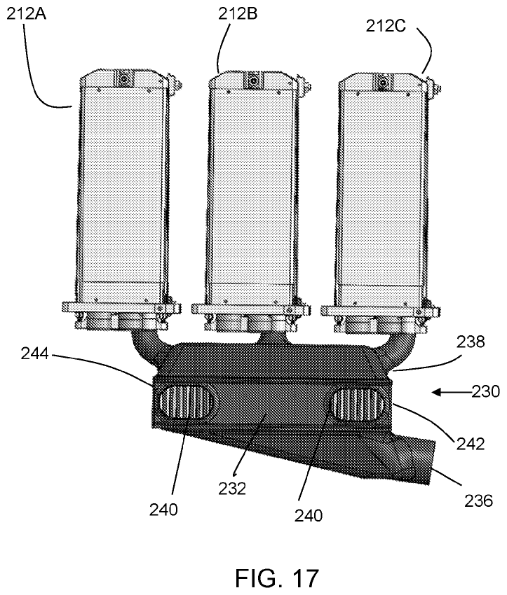

FIG. 17 is a side elevational view of a fuel cell superstack and including a humidifier directly mated to the inlet ports of the fuel cell stack in accordance with the present disclosure; and

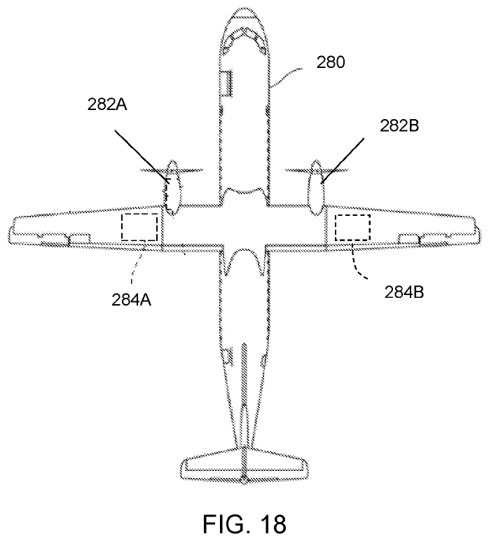

FIG. 18 is a schematic view of a hydrogen gas fuel cell powered airplane having a novel humidifier in accordance with the present disclosure.

Example embodiments will now be described more fully with reference to the accompanying drawings. Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected, or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer, or section. Terms such as “first,” “second,” and other numerical terms when used herein do not imply a sequence or order unless clearly indicated by the context. Thus, a first element, component, region, layer, or section discussed below could be termed a second element, component, region, layer, or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

As used herein, the term “fuel cell” is intended to include an electrochemical cell that converts the chemical energy of a fuel (typically hydrogen) and an oxidizing agent (typically oxygen) into electricity through a pair of redox reactions. There are many types of fuel cells, but they all include an anode, a cathode, and an electrolyte that allows ions, usually positively hydrogen ions or protons, to move between two sides of the fuel cell. At the anode, a catalyst causes the fuel to undergo oxidized reactions that generate ions, typically positively charged hydrogen ions, and electrons. The ions move from the anode to the cathode through the electrolyte. At the same time, electrons flow from the anode to the cathode through an external circuit, producing direct current electricity. At the cathode, another catalyst causes ions, electrons, and oxygen to react, forming water in the case of a hydrogen fuel cell, and possibly other products. Fuel cells are classified by the type of electrolyte they use and by the difference in startup electrolyte they use.

The present disclosure has particular applicability to proton-exchange membrane hydrogen fuel cells, or so-called hydrogen fuel cells, although the disclosure is not limited to hydrogen fuel cells and may be used with other fuel cells such as phosphoric acid fuel cells, solid oxide fuel cells, molten carbonate fuel cells, and alkaline fuel cells which are given as exemplary.

In the following description it is understood that an “intercooler” is a type of “heat exchanger”.

Referring to FIG. 2, there is illustrated a fuel cell stack 330 having one or more sensors 332A, 332B, 332C . . . external to the fuel cell surfaces 334A, 334B, 334C . . . respectively configured for detecting changes in external surfaces of the fuel cells. Sensors 332A, 332B, 332C . . . may comprise, for example, visual spectrum cameras, IR cameras, IR detectors, UV responsive cameras or the like. The sensors preferably are configured to detect changes in all six sides of the fuel cells. Only three sensors are shown for the convenience of illustration. It is understood however that detectors preferably are configured to observe all exterior surfaces of the fuel cell. That is to say sensors 332A, 332B, 332C . . . preferably are configured to cover the expanse of the entirety of one or more of surfaces 334A, 334B, 334C . . . of the fuel cell, where faults may be detected, and may include fisheye lenses or other means to ensure essentially full coverage, while minimizing spacing between the fuel cell and the sensors.

Referring to FIGS. 3 and 3A, in another embodiment, the sensors comprise ultrasound sensors 336A, 336B, 336C . . . configured to contact the fuel cell surfaces to detect sounds emanating from the fuel cell stack 330. Such sounds may comprise native sounds originating within the cells 330 or sounds induced, for example, by pulses, for example, from IR lasers 338A, 338B, 338C . . . directed toward the cells 330.

Referring to FIG. 4, in yet another embodiment, the sensors comprise vibration sensors or surface acoustic wave detectors 340A, 340B, 340C . . . affixed to external surface(s) of the cell for detecting vibrations originating within the cells.

Referring to FIG. 5 in still yet another embodiment, the sensors comprise piezo sensors 342A, 342B, 342C . . . affixed to or microfabricated within external surface(s) of the cells.

In still yet another embodiment, illustrated in FIG. 6, the sensors comprise mass spectrometry sensors 346A, 346B, 346C . . . configured to detect changes in the surfaces of the cell or fluid leakage from the cell, under illumination of ionizing beam from ionizers 348A, 348B, 348C . . . external to the cell.

FIG. 7 is a block diagram showing the use of fuel cell data 360 from, for example, sensors 332A, 332B, 332C . . . to generate indications 364 of faults 366 which can be used to flag and/or isolate the cause of a faulty function, abnormality, or problem in the fuel cell 360. Fuel cell data 360 also can be used to determine corrective actions 368 and/or shutdown based on the isolated problem. Fuel cell data 360 is collected or generated by the fuel cell 360 also may include data 372 of past sensor outputs stored in data logs 374. Corrective actions 368 can be made and include, for example, values based on sensor outputs and actuator and historical data stored in data logs 374 or based on other fuel cell data. For example, statistics can be used to determine cell performance, and/or trends in operation of the fuel cell 330 based on drifting values or changes in particular values or calculations for one or more of the sensor outputs over a period of time.

As so described, the present disclosure advantageously may be employed for monitoring hydrogen fuel cells and to diagnose a fault condition in a hydrogen fuel cell, including:
Any combustion of H₂
Leaking H₂
Cold spots (where insufficient O₂ or H₂ is making it to membrane)
Cold spots where H₂ is decompressed
Hot spots (bubble or blockage in coolant channels).
Input filter clogged.
Membrane distortion-measure of pressure difference across cell
Insufficient oxygen or hydrogen reaching parts of the PEM.
Overheating and bulging.
   Other faults such as deviation from normal or optimal temperature operating range which include:
LTPEM membrane −70-85° C. (heat created by proton traveling through membrane), min 50° C.—so requires pre-heat.
HTPEM membrane −120-250° C., so requires pre-heat
   Also, poor interconnection of bus bars and individual cells may lead to overheating. Existing systems for diagnosing fault connections in fuel cells typically employ thermocouples located at a few points in or on a fuel cell.

Various changes may be made without departing from the spirit and scope of the disclosure. For example, camera feed images and/or video incorporating Computer Vision algorithms (e.g., OpenCV) and/or algorithms trained using Machine learning (e.g., Linear regression, Logistic regression, Decision tree, SVM (Supervised Vector Machine) algorithms, Naive Bayes algorithms, KNN (Supervised Learning) algorithms, K-means (Unsupervised Learning) algorithms, Random forest algorithm, Dimensionality reduction algorithms, Gradient boosting algorithm, and AdaBoost algorithm). Video may be analyzed in hardware and/or efficient software, with the benefit that only changing date is stored and/or transmitted.

One embodiment may utilize machine learning algorithms to determine the most optimal control strategy and/or alerts based on a multitude of inputs. Also, we may utilize resulting models in real-time operation, or retrain the model for further updates throughout the useful life of the cell or create predictive maintenance alerts to prevent unscheduled occurrences.

Another embodiment employs deterministic algorithms to determine an optimal control strategy and/or alerts based on a multitude of inputs. e.g.:
Use a deterministic map to map inputs to outputs
Employ fixed cameras to identity regions that map to specific inputs.
Employ conditional probability e.g., Bayesian analysis, or generate data
Direct waves through liquid coolants to expose cell temperatures
Incorporate computing devices to process and interpret signals from sensors.
Image fuel cells from multiple viewpoints to create 3D images
Image electrical connections.
Employ cameras for detection of motion/distortion, interferometric or stereo amplification of cell surfaces
Employ Euleran image motion amplification detect distortion such as pressure changes, also for rotating machinery.
Employ ultrasound surface piezo sensors to detect uneven heating, and/or of fluid leaks.
Position cameras or sensors so that they can “see” a whole side of a cell
Detect water at an input side of the cathode side, optically with camera, such as by light scattered by droplets, or surface internal reflection changes, or total internal reflection detection.
Image or measure radiator faces to detect uneven heating, and/or low or partial fluid levels
Image or measure radiator faces to detect a location of the refrigerant phase change
Image or measure the anode wet side circulation loop to verify it is not too cool, which also may cause unwanted condensation
Employ machine learning to identify correlations between physical parameters such as too wet, too dry, too hot, too cold and cell performance.
Time of flight acoustic measurement of speed of sound to determine the H₂ content.
Mass spec measurement

The disclosure has particular utility for use in connection with fuel cells employed to power transportation equipment including airplanes, where fuel cell faults may strand passengers, or in extreme situations lead complete power loses resulting in crashes. In this regard, the disclosure may be applied to fault monitoring and alerting a pilot not only of internal fuel cell fault, but other faults of other aircraft components such as busbar with loose connections and overheating. For example, an infrared camera connected to the fault detection system may detect a high-temperature and disconnect relevant circuits automatically and/or warn the pilot or crew.

FIG. 8 illustrates a fuel cell stack having a fault detection system in accordance with the present disclosure installed in an airplane. The airplane 380 includes electric motors 382A, 382B which are supplied with electrical power by two parallel fuel cell systems 384A, 384B for driving the electric motors 382A, 382B and for powering other instruments and subsystems, e.g., flaps, instrumentation, etc. of the plane. The plane also may have one or more electrical storage units 388A, 388B in the form of batteries or in the form of high-power capacitors to temporarily store electrical energy arising in the fuel cell systems if this energy is not required to drive the motors 382A, 382B. The fuel cell systems are supplied with hydrogen and air (oxygen) by means of supply units (not shown). The hydrogen can thus be used to operate the fuel cell systems to power the airplane.

Various changes and advantages may be made in the above disclosure without departing from the spirit and scope thereof. For example, external surfaces of the fuel cells may be patterned (see FIG. 2, element 390) so that changes in surface conditions are more readily observable. Also, the system may employ machine learning or other image interpretation to suggest on-condition maintenance schedules or service requirements of the fuel cell stacks. Also, data gathered by the sensors may be logged for maintenance and/or regulatory requirements and/or sent to the pilot or crew, the Automated Flight Control System (AFCS), for autonomous flight, or stored and/or sent to telemetry-ground and/or other aircraft. Data gathered also may be utilized to optimize fuel cell control based on hydrogen remaining in the anode loop, to monitor hydrogen quality and/or optimize hydrogen concentration in the gas phase. Other embodiments may include a data transmission link to upload data from the aircraft and/or download models to the aircraft post-flight. Such embodiments may employ cloud processing of cross-fleet-of-aircraft data to incorporate fleet-wide learnings. Still other changes and advantages may be seen without departing from the spirit and scope of the disclosure.

Referring to FIG. 9, hydrogen fuel cell system 10 in accordance with another embodiment of the present disclosure includes a hydrogen fuel cell stack 12. Hydrogen fuel cell stack 12 includes a cathode section 14 and an anode section 16 separated by a proton exchange membrane (PEM) 18. Cathode section 14 includes a cathode air inlet 20 and a cathode exhaust 22 for unconsumed air and water produced in the cell, and an anode hydrogen gas inlet 24 and an anode outlet 26 via which unconsumed hydrogen gas is either vented or recycled. The hydrogen fuel cell system 10 also includes a compressor 28 in which inlet air for introduction into the cathode section 14 is compressed. Compressor 28 may be driven by an electric motor (not shown) which in turn is driven by electricity produced by the fuel cell. Alternatively, compressor 28 may be powered by another source of mechanical power (not shown). For convenience of illustration the electric motor and other components which make up a fuel cell powered aircraft, i.e., the balance of plant (BoP), are omitted.

In operation of the fuel cell, inlet air is compressed by compressor 28 for introduction into the cathode section 14 of the fuel cell stack 12. Compression of the air increases the temperature of the air. Since in the case of some types of HT-PEM hydrogen fuel cell, temperature of the fuel cell must be maintained within an operating range of 100° C. and 160° C. to operate efficiently, a cathode intercooler or heat exchanger 30 is positioned between compressor 28 outlet and cathode inlet 14. A fluid coolant is circulated through the fuel cell 12 via conduit 32, pump 34 and conduit 36 to maintain the fuel cell stack in the desired operating temperature range. In accordance with the present disclosure, the heat from the compressor acting on the cathode inlet air is initially used to pre-heat the fuel cell to heat the fuel cell to its desired operating temperature. Also, heat from operation of the fuel cell can be used to pre-heat the cathode inlet air. Heating control is managed by controlling pump 34 and/or via a valve 39 in line 32. Pump 34 and/or valve 39 are controlled via a controller 100.

Referring to FIG. 10, in a further embodiment, the cathode intercooler heat exchanger 30 is also used to pre-heat the anode hydrogen feed, in addition to cooling the cathode air feed. (For convenience of illustration, the optional primary coolant loop between the cathode intercooler heat exchanger and the fuel cell 12, including conduits 32 and 36 and pump 34 are omitted from FIG. 10). With this arrangement, anode hydrogen feed and cathode air feed can be made the same or similar temperatures to minimize thermal temperature differences in the fuel cell stack 12. As before flow of heat exchange fluid is controlled by pump and/or valves (not shown).

In the FIG. 10 embodiment the cathode air feed and the anode hydrogen gas feed must be segregated from one another by passing same through separate passages within the intercooler 30, in order to avoid mixing the air and hydrogen which would form a combustible mixture.

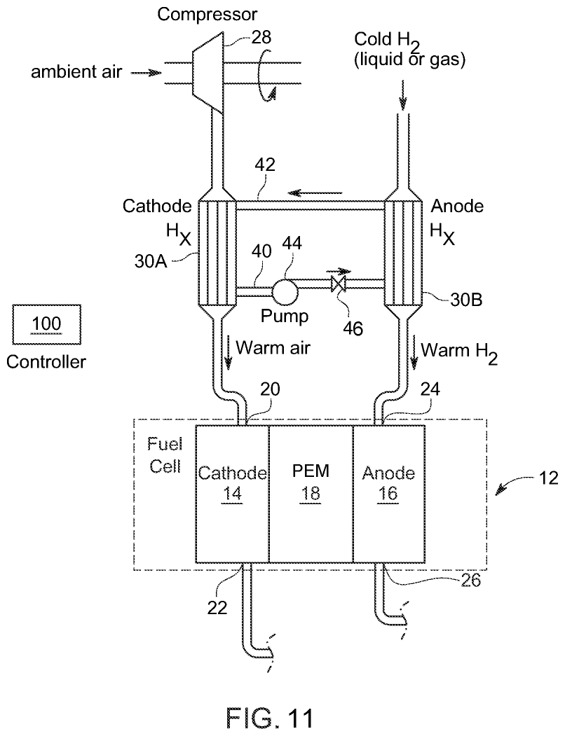

Referring to FIG. 11, in yet another embodiment, the heat transfer loop includes a first cathode intercooler heat exchanger 30A and a separate anode hydrogen gas heat exchanger 30B coupled via conduits 40 and 42 and pump 44 pre-heat the cathode inlet air. As in the case of FIG. 10, for convenience of illustration the primary coolant loop between the cathode intercooler or heat exchanger 30A and the fuel cell 12, including conduits 32 and 36, and pump 34 have been omitted from FIG. 11 for convenience of illustration.

Pump 44 is under controller 100, as before. This system illustrated in FIG. 11 also keeps the hot high-pressure air separated from the flammable hydrogen. Pump operating speed and/or valve 46 may be modulated to alter or control the rate of heat transfer between heat exchanger 30A and 30B, under control of controller 100.

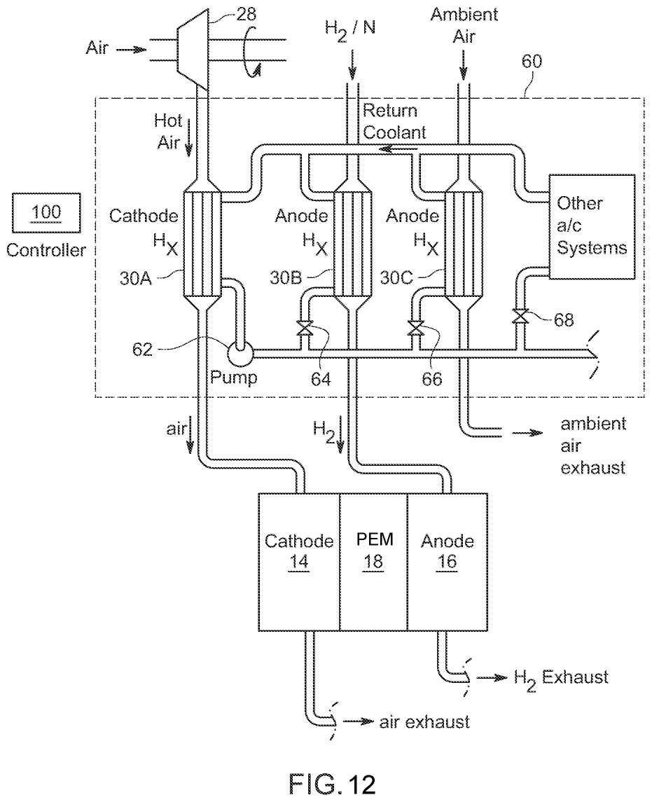

FIG. 12 illustrates yet another embodiment. In the FIG. 12 embodiment, a fluid heat transfer loop 60 is provided to transfer heat from the compressor cathode intercooler or heat exchanger 30A to anode hydrogen feed via heat exchanger 30B. An additional heat exchanger 30C is also provided for transferring heat from the cathode compressor intercooler to another aircraft system, such as the aircraft cabin. As in the case of FIGS. 10 and 11, the primary coolant loop between the cathode intercooler or heat exchanger 30A and the fuel cell 12 including conduits 32 and 36 and pump 34 are omitted for convenience of illustration. Control of fluid flow through heat transfer loop 60 is controlled by pump 62 and valves 64, 66 and 68. Pump 62 and valves 64, 66 and 68 are all controlled by controller 100.

Referring to FIG. 12, controller 100 is configured to manage flow of liquid and/or gaseous hydrogen, manage airflow from compressor 28 as well as manage hydrogen going into the fuel cell 12, manage rates of heated/cooled compressed air, and/or various flows and/or power of the fuel cell including mass flow of cathode exhaust into and out of the cathode heat exchanger 30A. The algorithm for managing these thermal managing components can be designed to ensure most efficient use of the various cooling and heating capacities of the respective gases and liquids to maximize efficiency of the system and minimize the volume and weight of same. For example, in one embodiment, the heat exchanger 30 should be controlled to bring the air input into the cathode side of the fuel cell to 100° C. at startup and to maintain the temperature of the air input and hydrogen gas input to maintain the integrated temperature of the fuel cell 12 to a range of 100° C. to 160° C.

FIG. 14 illustrates an aircraft 280 including two electric motors 102, 104 which are powered by two HT-PEM hydrogen fuel cells 106, 108 in accordance with the present disclosure.

Referring to FIG. 16, a fuel cell system in accordance with yet another embodiment of the present disclosure includes a superstack of three fuel cell stacks 212A, 212B, 212C. Fuel cell stacks 212A, 212B, 212C are connected in series and/or parallel to achieve a desired output voltage and current. The electrical connectors connecting fuel cell stacks 212A, 212B, and 212C are conventional and are not shown. Fuel cell stacks 212A, 212B, 212C each include an air inlet 218A, 218B, 218C configured for introduction of humidified air from a humidifier as will be described below, and air outlets 220A, 220B, 220C via which air is exhausted from the fuel cell stacks. Fuel cell stacks 212A, 212B, 212C also include air inlets 222A, 222B, 222C configured for introduction of pressurized air from the fuel cell system compressor (also not shown), and spent air outlets 224A, 224B, 224C configured to direct humid air exhaust from the cells 212A, 212B, 212C. The fuel cell stacks 212A, 212B, 212C also include coolant inlets 226A, 226B, 226C, and coolant recirculation outlets 228A, 228B, 228C.

As a practical matter, the fuel cell stacks are oriented downward in use, so that any water created in the reaction or condensing from the humidified air input drains from the cells.

Referring to FIG. 17, the fuel cell system also includes a humidifier 230 having a housing section 232 having a humidification chamber in the form of a hollow chamber. Humidifier 230 includes an air inlet port 236 for introducing air from the fuel cell system compressor (not shown) into the humidifier, and an integrated air outlet manifold section 238 via which humidified air is withdrawn and introduced into the inlets of the fuel cell stacks 212A, 212B, 212C. A plurality of diffusion membrane tubes 240 are located within housing 232 for carrying the air introduced from the compressor through the humidifier and into the air outlet manifold section 238 for introduction into the fuel cell stacks.

Humid air from the fuel cell exhaust is introduced into the humidification chamber via inlet 242, gives up water through the diffusion membrane tubes 240 to humidify the inlet air, and exits the humidifier via humidifier outlet 244 to exhaust.

A similarly shaped manifold, without the diffusion membrane tubes routes spent air, unreacted hydrogen, etc., from the fuel cell stacks.

FIG. 18 illustrates an airplane 280 which includes two electric motors 282A, 282B which are supplied by two hydrogen fuel cell system 284A, 284B including humidifier system in accordance with the preferred disclosure.

In one embodiment a superstack and the BOP are packaged as a modular cuboid standard subsystem for installation into a variety of aircraft.

Placing the humidifier, facing down, next to the superstack module increases the lateral size of the packaged BOP, making it harder to fit on the airplane. It also must still occupy the space below to route the air 180° underneath.

Another packaging technique could be to place the humidifier under the superstack/BOP subsystem. With a conventional humidifier, this creates an irregular shape as only half of the humidifier (the wet inlet and dry outlet) are under the superstack cube, and the dry inlet and wet outlet must protrude out of the envelope.

To minimize volume requirements, we may customize the aspect ratio of the humidifier and the inlet/outlet configurations such that it can occupy the volume immediately below the superstack cube with the shortest possible tube routing and lowest overall volume.

One packaging technique is to provide a slim humidifier that, in an inlets-down orientation, trades width for both height and depth. This slim humidifier can occupy a similar lateral envelope to the superstack such that it stacks neatly beneath it when placed on its side, or alternatively if placed in a vertical orientation next to or in front of the superstack, adds the least width possible to the superstack's horizontal envelope.

A further possibility is to integrate the humidifier's core directly into the structure of the inlet manifold of the fuel cell stack. This saves on structural material and mass by sharing walls between flow channels and decreases the maximum overall height of the Superstack/BOP package.

Fluid management occurs in the triple fluid management manifold, or ‘mono-manifold’ as referred to herein. This mono-manifold is a single structure containing all flow channels valves, injectors and sensors included in the BOP for all 3 fluids. The mono-manifold can take on one of two forms: 1) mated to a humidifier, possibly with custom intake ports, mounted underneath or next to the fuel cell BOP, or 2) the humidifier core, the membrane tube bundle, is installed directly into a fully integrated compartment of the mono-manifold.

The mono-manifold may be manufactured through a sandwich design wherein multi-layer 2D flow channels and interfaces are machined into flat stacking plates of a suitable material, e.g., aluminum, titanium, stainless steel, or plastic and bonded together. In another embodiment, the mono-manifold may be manufactured through a spaghetti design wherein the techniques of Stereolithography 3D printing (SLA) and/or Selective Laser Sintering (SLS) are used to form complex 3D flow channels and structures in aluminum, plastic, stainless steel, and/or titanium.

Metal mono-manifolds may be coated in insulative material to reduce conductivity. Additive methods may use a coating or surface treatment to reduce porosity (e.g., MEK bath for polycarbonate parts reduces porosity and increases smoothness).

As can be seen from the foregoing disclosure as a result of our novel superstack arrangement of multiple fuel cell stacks, coupled with the novel humidifier with integral manifold which permits us to directly mate our humidifier to the inlet ports of the individual fuel cell stacks, the BOP of our fuel cell system is significantly reduced in size and weight as compared to a conventional fuel cell system.

While the foregoing disclosure is focused primarily on HT-PEM fuel cell applications, disclosure also may be advantageously used in connection with low temperature proton exchange membrane (LT-PEM) fuel cell applications, and with other fuel cell applications including by way of example but not limitation methanol fuel cells and ethanol fuel cells.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure. Various changes and advantages may be made in the above disclosure without departing from the spirit and scope thereof.

1-16. (canceled)

17. A fuel cell having a cathode and an anode, a cathode air feed and an anode gas feed; a cathode air feed compressor; and a first heat exchanger loop including a cathode intercooler heat exchanger configured to extract heat from the compressed cathode air feed, wherein the first heat exchanger loop is configured to circulate a heat exchanger fluid from the cathode intercooler heat exchanger to the fuel cell to pre-heat the fuel cell during fuel cell start up, and a second heat exchanger loop, separate from the first heat exchanger loop, configured to pre-heat the anode gas feed before it enters the fuel cell so as to minimize thermal difference of the cathode air feed and the anode gas feed to the fuel cell, wherein the first heat exchanger loop and the second heat exchanger loop share the cathode intercooler heat exchanger.

18. The fuel cell of claim 17, wherein the anode gas feed and the cathode air feed are maintained separate from one another in the second heat exchanger loop.

19. The fuel cell of claim 17, wherein the fuel cell comprises a hydrogen fuel cell.

20. The fuel cell of claim 17, wherein the fuel cell is a high temperature proton exchange membrane (HT-PEM) hydrogen fuel cell.

21. A fuel cell powered vehicle comprising a fuel cell as claimed in claim 17.

22. The fuel cell powered vehicle of claim 21, wherein the vehicle comprises a fuel cell powered aircraft.

23. The fuel cell powered vehicle of claim 22, wherein the second heat exchanger loop is configured to transfer heat from the first compressor heat exchanger loop to other systems of the aircraft.

24. The fuel cell powered vehicle of claim 23, wherein the second heat exchanger loop is configured to transfer heat to the aircraft cabin.

25. A method for pre-heating a fuel cell during startup wherein the fuel cell comprises a fuel cell as claimed in claim 17, said method comprising circulating a heat exchanger fluid in the first heat exchanger loop from the cathode intercooler heat exchanger to the fuel cell to pre-heat the fuel cell during fuel cell startup.

26. The method of claim 25, further comprising selectively allowing circulating heat exchange fluid from the fuel cell to pre-heat the cathode inlet air.

27. The method of claim 25, wherein the anode gas feed and cathode air feed are heated to minimize thermal differences and stresses in the fuel cell.

28. The method of claim 25, wherein the second heat exchanger loop comprises the cathode intercooler heat exchanger and an anode gas feed heat exchanger, and comprising coupling the cathode intercooler exchanger and the anode gas feed exchanger via a heat exchanger transfer loop.

29. The method of claim 25, wherein the fuel cell comprises a hydrogen fuel cell.

30. The method of claim 29, wherein the hydrogen fuel cell comprises a high temperature proton exchange membrane (HT-PEM) hydrogen fuel cell.
